(19) United States
(12) Patent Application Publication
(10) Pub. No.: US 2025/0327938 A1
(43) Pub. Date: Oct. 23, 2025

(54) VEHICLE POSITIONING METHOD AND SYSTEM IN WEAK GNSS ENVIRONMENT

(71) Applicant: Chang'an University, Xi'an (CN)

(72) Inventors: Haigen MIN, Xi'an (CN); Xia WU, Xi'an (CN); Yukun FANG, Xi'an (CN); Shixiang CHEN, Xi'an (CN); Xiangmo ZHAO, Xi'an (CN); Wuqi WANG, Xi'an (CN); Yao LI, Xi'an (CN); Xiaoping LEI, Xi'an (CN); Sen XIA, Xi'an (CN); Changlei YAN, Xi'an (CN); Lisha CHEN, Xi'an (CN); Long YANG, Xi'an (CN); Chunyun ZHENG, Xi'an (CN)

(73) Assignee: Chang'an University, Xi'an (CN)

(21) Appl. No.: 19/255,679

(22) Filed: Jun. 30, 2025

Related U.S. Application Data
(63) Continuation of application No. PCT/CN2024/144303, filed on Dec. 31, 2024.

(30) Foreign Application Priority Data
Apr. 7, 2024 (CN) 2024104097279

(51) Int. Cl. G01S 19/49

(52) U.S. Cl. CPC G01S 19/49

(57) ABSTRACT

The present disclosure provides a vehicle positioning method and system in a weak GNSS environment. The method includes: preprocessing system operation data information of an autonomous vehicle, where the system operation data information includes latitude and longitude data acquired from the GNSS system and three-axis acceleration, three-axis angular velocity and heading information acquired from an INS system; training a position prediction network with the preprocessed system operation data information acquired from the INS system to finally output supervision information of the prediction network; training a position correction network according to the supervision information in step S2 and the preprocessed system operation data information and the supervision information of the position correction network; and finally outputting a predicted value for correction. In the weak GNSS environment or in case of GNSS interruption, the final predicted value is outputted through the position prediction network and the position correction network.

### CROSS-REFERENCE TO RELATED APPLICATIONS

The application claims priority to Chinese patent application No. 2024104097279, filed on Apr. 7, 2024, the entire contents of which are incorporated herein by reference.

### TECHNICAL FIELD

The present disclosure belongs to the field of electrical testing, and in particular, to a vehicle positioning method and system in a weak GNSS environment.

### BACKGROUND

An autonomous vehicle positioning system is designed to provide a vehicle with location information that meets certain accuracy requirements to assist the vehicle in making intelligent decisions. The vehicle positioning technology is a basic technology that integrates many high technologies such as sensor technology, computer technology, communication technology, information processing technology, and artificial intelligence technology. The global navigation satellite system (GNSS) and the inertial navigation system (INS) are two commonly used systems for ground vehicle positioning.

In some scenarios (such as tunnels and urban canyons), GNSS signals cannot be received by the corresponding signal receivers due to obscuration, while the INS has the defect of accumulated positioning errors. The combination of the two may improve the performance of the positioning system to a certain extent, but it is still difficult to meet the positioning requirements in complex environments.

One solution to the problem of how to continuously and stably provide position information that meets accuracy requirements under weak GNSS signal conditions is to add more vehicle-mounted sensors for auxiliary positioning. However, this method increases the hardware cost and complexity of the system, and also places higher requirements on the multi-sensor data fusion algorithm.

The present disclosure provides a vehicle positioning method and system in a weak GNSS environment to solve the problem of how to improve the vehicle positioning performance of the GNSS/INS integrated navigation system under weak GNSS conditions by training a position prediction network and a position correction network in stages without adding additional sensors and only using the data of the GNSS/INS integrated navigation system.

In order to solve the above technical problems, the present disclosure provides a vehicle positioning method in a weak GNSS environment, which includes:
step S1: preprocessing system operation data information of an autonomous vehicle in a normal driving state, where the system operation data information comprises latitude and longitude data acquired from a GNSS system and three-axis acceleration, three-axis angular velocity, and heading information acquired from an INS system;
step S2: training a position prediction network with the preprocessed three-axis acceleration, three-axis angular velocity, and heading information acquired from the INS system; by taking the three-axis acceleration, three-axis angular velocity, and heading information acquired from the INS system as inputs of the trained prediction network, outputting supervision information of the prediction network composed of a difference value between a measured value of the GNSS system and a measured value of the INS system;
step S3: training a position correction network according to the supervision information in the step S2 and the preprocessed three-axis acceleration, three-axis angular velocity, heading information, and the supervision information of the position correction network acquired from the INS system; and similarly, by taking the three-axis acceleration, three-axis angular velocity, and heading information acquired from the INS system as inputs of the trained position correction network, outputting an error between a position predicted value and a measured value of the GNSS system to correct a predicted value of the position prediction network; and
step S4: in a weak GNSS environment or in case of GNSS interruption, by taking first-order differences of the three-axis acceleration, three-axis angular velocity, and heading information acquired from the INS system and posture information of the autonomous vehicle as inputs of the trained position prediction network and the position correction network, further correcting the predicted value outputted by the position prediction network to obtain a final predicted value of position information of the autonomous vehicle.

Optionally, preprocessing system operation data information of the automatic vehicle in a normal driving state includes:
complementing all erroneous or incomplete fields in the system operation data information by means of linear interpolation.

Optionally, the supervision information of the prediction network is a difference value between the position measured value of the GNSS system and the position measured value of the INS system in the same coordinate system.

Optionally, the supervision information of the position correction network is a difference value between the position predicted value of the GNSS system and the position predicted value of the position prediction network in the same coordinate system.

Optionally, the position predicted value of the position prediction network is a sum of the supervision information of the prediction network and the three-axis acceleration, three-axis angular velocity, and heading information acquired from the corrected INS system.

Optionally, two hidden layers of an LSTM network of the position prediction network are arranged, a network input layer has 7 neurons, a length of inputted time series data is 30, and an output layer comprises three neurons.

Optionally, two hidden layers of an LSTM network of the position correction network are arranged, and an output layer comprises three neurons.

The present disclosure further provides a vehicle positioning system in a weak GNSS environment, which includes:
a data acquisition module configured to preprocess system operation data information of an autonomous vehicle in a normal driving state, where the system operation data information includes latitude and longitude data acquired from a GNSS system and three-axis acceleration, three-axis angular velocity, and heading information acquired from an INS system;
a position prediction network module configured to train a position prediction network with the preprocessed three-axis acceleration, three-axis angular velocity, and heading information acquired from the INS system; and, by taking the three-axis acceleration, three-axis angular velocity, and heading information acquired from the INS system as inputs of the trained prediction network, output the supervision information of the prediction network composed of a difference value between a measured value of the GNSS system and a measured value of the INS system;
a position correction network module configured to train a position correction network according to the supervision information in Step S2 and the pre-processed three-axis acceleration, three-axis angular velocity, heading information, and supervision information of the position correction network acquired from the INS system; similarly, by taking the three-axis acceleration, three-axis angular velocity, and heading information acquired from the INS system as inputs of the trained position correction network, output an error between the position predicted value and a measured value of the GNSS system, to correct a predicted value of the position prediction network; and
an output module configured to, in a weak GNSS environment or in case of GNSS interruption, by taking first-order differences of the three-axis acceleration, three-axis angular velocity, and heading information acquired from the INS system and posture information of the autonomous vehicle as inputs of the trained position prediction network and the position correction network, further correct the predicted value outputted by the position prediction network to obtain a final predicted value of position information of the autonomous vehicle.

The present disclosure further provides a computer device, which includes a memory, a processor, and a computer program stored in the memory and executable on the processor, where the processor, when executing the computer program, implements the steps of the vehicle positioning method in a weak GNSS environment according to any one of above embodiments.

The present disclosure further provides a computer-readable storage medium storing a computer program, where when executed by a processor, the computer program implements the steps of the vehicle positioning method in a weak GNSS environment according to any one of the above embodiments.

The present disclosure has the following beneficial effects:

The objective of the present disclosure is to provide a vehicle positioning method and system in a weak GNSS environment without adding other vehicle-mounted sensors. This method trains the position prediction neural network and the position correction neural network in stages to improve the vehicle positioning performance of the GNSS/INS integrated navigation system under weak GNSS conditions. Both neural networks use the outputs of the inertial navigation system as network inputs. In the first stage, the error between the GNSS system and the INS system is used as supervision information to train the position prediction network; in the second stage, the residual error between GNSS measured value and GNSS predicted value is used as supervision information to train the position correction network. The trained prediction network and correction network are used simultaneously to predict the vehicle position in the weak GNSS environment.

### BRIEF DESCRIPTION OF DRAWINGS

FIG. 1 is a flowchart of steps of a vehicle positioning method a in a weak GNSS environment provided by the present disclosure;

FIG. 2 is a schematic diagram of installation of related devices such as a GNSS/INS micro-electromechanical system and a GNSS antenna provided by the present disclosure;

FIG. 3 is a schematic diagram of a training process of a position prediction network and a position correction network provided by the present disclosure;

FIG. 4 is a schematic diagram of use of a position prediction network and a correction network provided by the present disclosure in a weak GNSS environment or in case of GNSS interruption;

FIG. 5 is a schematic diagram of a process from training to using a position prediction network and a position correction network provided by the present disclosure; and

FIG. 6 is a schematic diagram of a vehicle positioning system in a weak GNSS environment provided by the present disclosure.

### DETAILED DESCRIPTION OF THE EMBODIMENTS

In order to make those skilled in the art better understand the solution of the present disclosure, the technical solutions in the embodiments of the present disclosure will be clearly and completely described below in conjunction with the drawings in the embodiments of the present disclosure. Apparently, the described embodiments are only embodiments of a part of the present disclosure, rather than all the embodiments. Based on the embodiments of the present disclosure, all other embodiments obtained by those of ordinary skill in the art without making creative labor should fall within the scope of protection of the present disclosure.

It should be noted that the terms “first”, “second”, and the like in the Description and Claims of the present disclosure and the above drawings are used to distinguish similar objects, and are not necessarily used to describe a specific order or sequence. It is to be understood that the terms so used are interchangeable under appropriate circumstances such that the embodiments of the present disclosure described herein are capable of being practiced in sequences other than those illustrated or described herein. In addition, the terms “comprises,” “comprising,” and “having,” and any variations thereof, are intended to cover non-exclusive inclusions. For example, a process, method, system, product, or apparatus that includes a series of steps or elements is not necessarily limited to those steps or elements explicitly listed, but may include other steps or elements not explicitly listed or inherent to such process, method, product, or apparatus.

The present disclosure is described in detail below with reference to the accompanying drawings and specific embodiments.

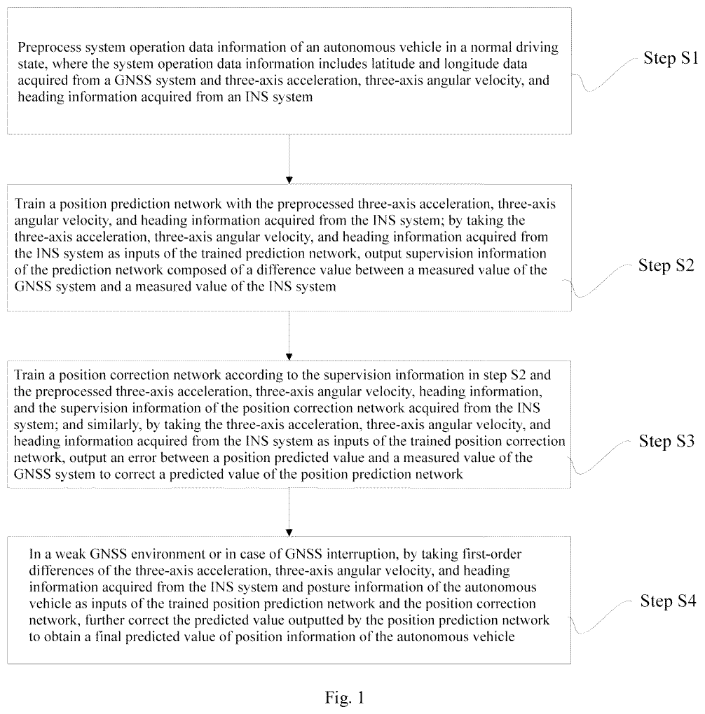

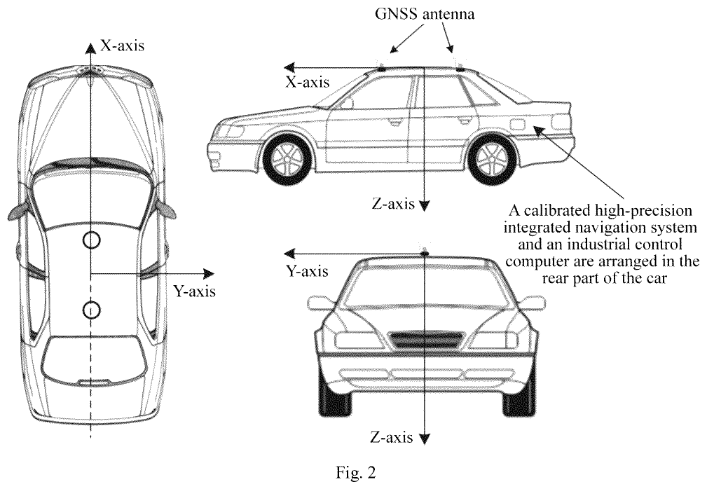

The present disclosure provides a vehicle positioning method in a weak GNSS environment, as shown in FIG. 1. It should be noted that, in this embodiment, a GNSS/INS combined navigation system is taken as an example, and the data acquisition device used includes a high-precision micro-electromechanical combined navigation system installed in the vehicle and a set of GNSS antennas for receiving satellite signals, an industrial control computer for recording the GNSS logs of the combined navigation system, and a power supply device supporting the above device. The device installation is shown in FIG. 2. The calibrated integrated navigation system and industrial control computer are fixed on the rear part of the car and connected to the GNSS antenna through a feeder. The GNSS antennas are screwed onto two strong magnetic chucks and fixed in the forward and backward directions of the autonomous vehicle. They should be placed at the highest point of the autonomous vehicle as much as possible to ensure that they can receive good GNSS signals. At the same time, it is necessary to ensure that the connecting line formed by the phase centers of the two GNSS antennas is consistent with or parallel to the central axis of the test carrier.

In conjunction with FIG. 1, the method includes:
Step S1: preprocessing system operation data information of an autonomous vehicle in a normal driving state, where the system operation data information comprises latitude and longitude data acquired from a GNSS system and three-axis acceleration, three-axis angular velocity, and heading information acquired from an INS system. In an embodiment, the system operation data information of the autonomous vehicle in a normal driving state is acquired from the autonomous sensor of the autonomous vehicle, and GNSS data and INS data of the autonomous vehicle when the autonomous vehicle is running are extracted from the acquired system operation data information, which includes:
lat,lon,ωₓ,ω_{y},ω_{z},αₓ,α_{y}, α_{z},β
where, lat represents the latitude data acquired from the GNSS system, and ion represents the longitude data acquired from the GNSS system (unit: degree), ωₓ,ω_{y},ω_{z} respectively represent the three-axis angular velocities in the x-axis, y-axis, and z-axis directions acquired from the INS system (unit:degree/s), αₓ,α_{y},α_{z} respectively represent the three-axis accelerations in the x-axis, y-axis, and z-axis directions acquired from the INS system (unit: gravitational acceleration g), and f represents the heading.
Step S2: training a position prediction network with the preprocessed three-axis acceleration, three-axis angular velocity, and heading information acquired from the INS system; by taking the three-axis acceleration, three-axis angular velocity, and heading information acquired from the INS system as inputs of the trained prediction network, outputting supervision information of the prediction network composed of a difference value between a measured value of the GNSS system and a measured value of the INS system;
in an embodiment, for the longitude and latitude data acquired from the GNSS system, position information obtained through Mercator projection is recorded as p_{GNSS}, and for the three-axis acceleration, three-axis angular velocity, and heading information acquired from the INS system, position information obtained through mathematical integration is recorded as p_{INS}.

The three-axis acceleration, three-axis angular velocity, and heading information obtained from the INS system are used as the vehicle posture information Ψ of the network, including ωₓ,ω_{y},ω_{z},αₓ,α_{y},α_{z} The vehicle posture information, the first-order difference of the posture information Δ_{Ψ}, and the heading information β are used as the inputs of the position prediction network.

The difference Δp between p_{GNSS} and p_{INS} in the same coordinate system is used as the supervision information of the position prediction network to train the position prediction network.

It is noted that the input information of the network is taken from the INS system. After training, the position prediction network will have the ability to use the INS system information as input to predict the GNSS position p′_{GNSS}, and output the supervision information of the prediction network composed of the difference value between a measured value of the GNSS system and a measured value of the INS system for use in the position correction network training.
Step S3: training a position correction network according to the supervision information in the step S2 and the preprocessed three-axis acceleration, three-axis angular velocity, heading information, and the supervision information of the position correction network acquired from the INS system; and similarly, by taking the three-axis acceleration, three-axis angular velocity, and heading information acquired from the INS system as inputs of the trained position correction network, outputting an error between a position predicted value and a measured value of the GNSS system to correct a predicted value of the position prediction network.

In an embodiment, the network still uses the vehicle attitude information Ψ, the first-order difference of the attitude information Δ_{T}, and the heading information β as inputs of the position correction network, and uses the error eₚ between the measured value p_{GNSS} of the GNSS system and the predicted value p′_{GNSS} of the prediction network as the supervision information of the position correction network to train the network. The input information of the network is also taken from the INS system. After training, the position correction network outputs the error between a position predicted value and the measured value the GNSS system, and corrects the predicted value of the position prediction network.

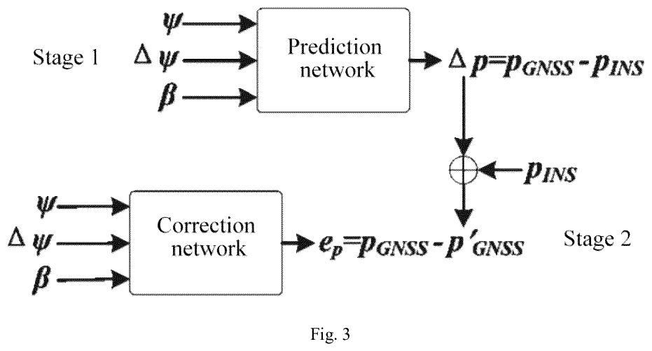

It should be noted that, as shown in FIG. 3, the training process of step S2 and step S3 includes two stages: stage 1, a position prediction network training process; stage 2: a position correction network training process.
Step S4: In a weak GNSS environment or in case of GNSS interruption, by taking first-order differences of the three-axis acceleration, three-axis angular velocity, and heading information acquired from the INS system and posture information of the autonomous vehicle as inputs of the trained position prediction network and the position correction network, further correcting the predicted value outputted by the position prediction network to obtain a final predicted value of position information of the autonomous vehicle.

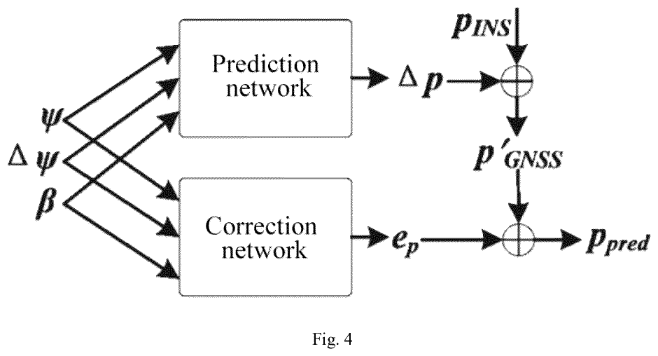

In an embodiment, as shown in FIG. 4, in a weak GNSS environment or in case of GNSS interruption, the positioning system cannot acquire position information from the GNSS system, and the inputs of the above position prediction network and correction network are both taken from the INS system, so it may be used in a weak GNSS environment or in case of GNSS interruption, as shown in FIG. 4. When in use, the vehicle attitude information Ψ, the first-order difference of the attitude information Δ_{Ψ}, and the heading information β are simultaneously inputted into the two networks. At this time, the position prediction network will predict the vehicle position based on the information given by the INS system, and combine with p_{INS} to obtain p′_{GNSS}. At the same time, the position correction network will output the error information eₚ, and further correct the predicted value p′_{GNSS} given by the prediction network to obtain the final output value p_{pred} of the vehicle position information.

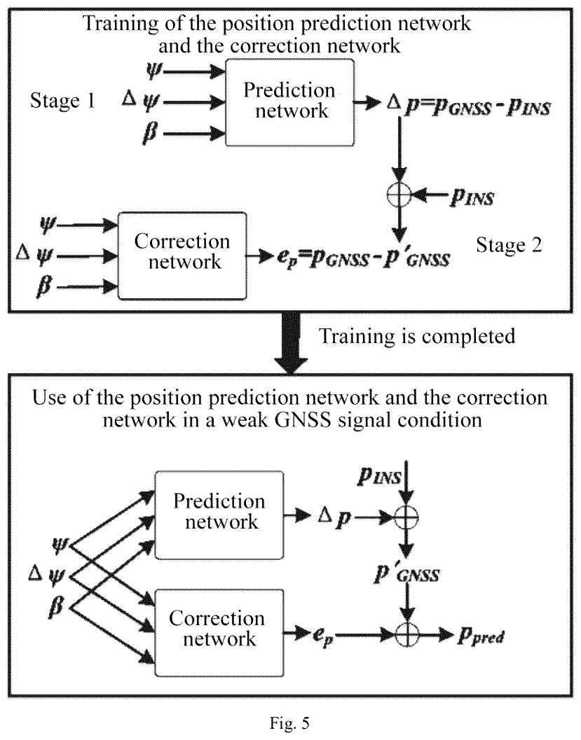

In this embodiment, as shown in FIG. 5, the present disclosure provides a vehicle positioning method in a weak GNSS environment. This method respectively trains the position prediction network and the position correction network in two stages. In the first stage, the position prediction network is trained using the error between the GNSS system and the INS system as supervision information. After the training is completed, the position prediction network will have the ability to use the INS system information as input to predict the vehicle position. In the second stage, the residual error between the GNSS measured value and the GNSS predicted value is used as the supervision information to train the position correction network. After the training is completed, the position correction network will be able to further correct the prediction value given by the prediction network. Both networks use the INS system data as input, ensuring the availability of positioning functions in weak GNSS environments or in case of GNSS interruption.

Optionally, preprocessing system operation data information of the automatic vehicle in a normal driving state includes: complementing all erroneous or incomplete fields in the system operation data information by means of linear interpolation.

In an embodiment, in Step S1, the directly acquired data contains erroneous or incomplete fields. In this case, the system operation data information of the autonomous vehicle in the normal driving state needs to be preprocessed. The extracted data information file still has incomplete, missing and duplicate records and cannot be directly used as input to the model for training. In the present disclosure, one duplicate record is retained, and for samples with incomplete or erroneous fields, the erroneous or incomplete fields are completed using linear interpolation of the corresponding fields of the two adjacent samples in front of and behind the sample, and the preprocessed data is used as training data for the neural network. Eliminating erroneous or incomplete fields may improve the accuracy of the network during training.

Optionally, the supervision information of the prediction network is a difference value between the position measured value of the GNSS system and the position measured value of the INS system in the same coordinate system.

Optionally, the supervision information of the position correction network is a difference value between the position predicted value of the GNSS system and the position predicted value of the position prediction network in the same coordinate system.

Optionally, the position predicted value of the position prediction network is a sum of the supervision information of the prediction network and the three-axis acceleration, three-axis angular velocity, and heading information acquired from the corrected INS system.

Optionally, two hidden layers of an LSTM network of the position prediction network are arranged, a network input layer Has 7 neurons, corresponding to 7 input variables: three-axis acceleration, three-axis angular velocity, heading, a length of inputted time series data is 30, and an output layer includes three neurons corresponding to three-dimensional spatial position differences between p_{GNSS} and p_{INS}.

Optionally, two hidden layers of an LSTM network of the position correction network are arranged, and an output layer includes three neurons corresponding to three-dimensional spatial differences between the measured value _{pGNSS} and the predicted value p′_{GNSS} of the GNSS system. It should be noted that the above network hyperparameters may be adjusted according to actual training conditions.

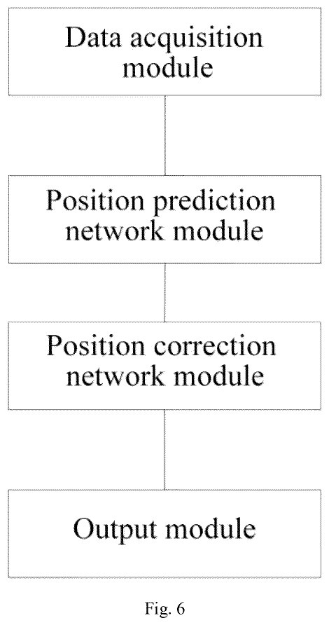

The present disclosure further provides a vehicle positioning system in a weak GNSS environment, as shown in FIG. 6, which includes:
a data acquisition module configured to preprocess system operation data information of an autonomous vehicle in a normal driving state, where the system operation data information includes latitude and longitude data acquired from a GNSS system and three-axis acceleration, three-axis angular velocity, and heading information acquired from an INS system;
a position prediction network module configured to train a position prediction network with the preprocessed three-axis acceleration, three-axis angular velocity, and heading information acquired from the INS system; and, by taking the three-axis acceleration, three-axis angular velocity, and heading information acquired from the INS system as inputs of the trained prediction network, output the supervision information of the prediction network composed of a difference value between a measured value of the GNSS system and a measured value of the INS system;
a position correction network module configured to train a position correction network according to the supervision information in Step S2 and the pre-processed three-axis acceleration, three-axis angular velocity, heading information, and supervision information of the position correction network acquired from the INS system; similarly, by taking the three-axis acceleration, three-axis angular velocity, and heading information acquired from the INS system as inputs of the trained position correction network, output an error between the position predicted value and a measured value of the GNSS system, to correct a predicted value of the position prediction network; and
an output module configured to, in a weak GNSS environment or in case of GNSS interruption, by taking first-order differences of the three-axis acceleration, three-axis angular velocity, and heading information acquired from the INS system and posture information of the autonomous vehicle as inputs of the trained position prediction network and the position correction network, further correct the predicted value outputted by the position prediction network to obtain a final predicted value of position information of the autonomous vehicle.

It should be noted that the present system may implement the vehicle positioning method in a weak GNSS environment in the above method embodiment, which will not be described in detail here.

The present disclosure further provides a computer device, including a memory, a processor, and a computer program stored in the memory and executable on the processor, where the processor, when executing the computer program, implements the steps of the vehicle positioning method in a weak GNSS environment according to any one of above embodiments. In yet another embodiment of the present disclosure, a terminal device is provided. The terminal device includes a processor and a memory, where the memory is configured to store a computer program, the computer program includes a program instruction, and the processor is configured to execute the program instruction stored in the computer storage medium. The processor may be a central processing unit (CPU), or another general-purpose processor, digital signal processor (DSP), application-specific integrated circuit (ASIC), field-programmable gate array (FPGA) or other programmable logic device, discrete gate or transistor logic device, discrete hardware component and the like.it is the computing core and control core of the terminal, which is suitable for implementing one or more instructions, and is specifically suitable for loading and executing one or more instructions to implement the corresponding method flow or corresponding function; the processor described in the embodiment of the present disclosure may be used for operating the vehicle positioning method in a weak GNSS environment.

The present disclosure further provides a computer-readable storage medium, which stores a computer program, where when executed by a processor, the computer program implements the steps of the vehicle positioning method in a weak GNSS environment as described in any one of the above embodiments.

In yet another embodiment of the present disclosure, the present disclosure further provides a storage medium, specifically a computer-readable storage medium (Memory), where the computer-readable storage medium is a memory device in a terminal device, and is configured to store programs and data. It is understandable that the computer-readable storage medium herein may include a built-in storage medium in the terminal device, and of course may also include an extended storage medium supported by the terminal device. The computer-readable storage medium provides a storage space in which an operating system of the terminal is stored. In addition, the storage space also stores one or more instructions suitable for being loaded and executed by the processor. These instructions may be one or more computer programs (including program codes). It should be noted that the computer-readable storage medium here may be a high-speed RAM memory, or a non-volatile memory, such as at least one disk memory. The processor may load and execute one or more instructions stored in the computer-readable storage medium to implement the corresponding steps of the vehicle positioning method in a weak GNSS environment in the above embodiment.

Those skilled in the art should understand that the embodiments of the present application may be provided as methods, systems, or computer program products. Therefore, the present application may take the form of an entirely hardware embodiment, an entirely software embodiment, or an embodiment combining software and hardware aspects. Moreover, the present application may take the form of a computer program product implemented in one or more computer-usable storage media (including, but not limited to, a disk memory, a CD-ROM, an optical memory, and the like) containing computer-usable program codes.

The present application is described with reference to flowcharts and/or block diagrams of methods, devices (systems), and computer program products according to embodiments of the present application. It should be understood that each process and/or block in the flowchart and/or block diagram, and a combination of the processes and/or blocks in the flowchart and/or block diagram may be implemented by computer program instructions. These computer program instructions may be provided to a processor of a general-purpose computer, a special-purpose computer, an embedded processor or other programmable data processing device to produce a machine, so that the instructions executed by the processor of the computer or another programmable data processing device generate a device for implementing the functions specified in one or more processes in the flowchart and/or one or more blocks in the block diagram.

These computer program instructions may also be stored in a computer-readable memory that may direct a computer or another programmable data processing device to work in a specific manner, so that the instructions stored in the computer-readable memory produce a manufactured product including an instruction device that implements the functions specified in one or more processes in the flowchart and/or one or more boxes in the block diagram.

These computer program instructions may also be loaded into a computer or another programmable data processing device, so that a series of operational steps are executed in the computer or another programmable device to produce a computer-implemented process, whereby the instructions executed on the computer or another programmable device provide steps for implementing the functions specified in one or more processes in the flowchart and/or one or more boxes in the block diagram.

Finally, it should be noted that the above embodiments are only used to illustrate the technical solutions of the present disclosure, rather than to limit the present disclosure. Although the present disclosure is described in detail with reference to the above embodiments, those skilled in the art should understand that the specific embodiments of the present disclosure may still be modified or replaced by equivalents, and any modification or equivalent replacement that does not depart from the spirit and scope of the present disclosure shall be included in the scope of protection of the claims of the present disclosure.

1. A vehicle positioning method in a weak GNSS environment, comprising:
step S1: preprocessing system operation data information of an autonomous vehicle in a normal driving state, wherein the system operation data information comprises latitude and longitude data acquired from a GNSS system and three-axis acceleration, three-axis angular velocity, and heading information acquired from an INS system;
step S2: training a position prediction network with the preprocessed three-axis acceleration, three-axis angular velocity, and heading information acquired from the INS system; by taking the three-axis acceleration, three-axis angular velocity, and heading information acquired from the INS system as inputs of the trained prediction network, outputting supervision information of the prediction network composed of a difference value between a measured value of the GNSS system and a measured value of the INS system;
step S3: training a position correction network according to the supervision information in the step S2 and the preprocessed three-axis acceleration, three-axis angular velocity, heading information, and the supervision information of the position correction network acquired from the INS system; and similarly, by taking the three-axis acceleration, three-axis angular velocity, and heading information acquired from the INS system as inputs of the trained position correction network, outputting an error between a position predicted value and a measured value of the GNSS system to correct a predicted value of the position prediction network; and
step S4: in a weak GNSS environment or in case of GNSS interruption, by taking first-order differences of the three-axis acceleration, three-axis angular velocity, and heading information acquired from the INS system and posture information of the autonomous vehicle as inputs of the trained position prediction network and the position correction network, further correcting the predicted value outputted by the position prediction network to obtain a final predicted value of position information of the autonomous vehicle,
wherein preprocessing system operation data information of the automatic vehicle in a normal driving state comprises:
complementing all erroneous or incomplete fields in the system operation data information by means of linear interpolation;
wherein the supervision information of the prediction network is a difference value between the position measured value of the GNSS system and the position measured value of the INS system in a same coordinate system.

2. (canceled)

3. (canceled)

4. The vehicle positioning method in a weak GNSS environment according to claim 1, wherein the supervision information of the position correction network is a difference value between the position predicted value of the GNSS system and the position predicted value of the position prediction network in the same coordinate system.

5. The vehicle positioning method in a weak GNSS environment according to claim 4, wherein the position predicted value of the position prediction network is a sum of the supervision information of the prediction network and the three-axis acceleration, three-axis angular velocity, and heading information acquired from the corrected INS system.

6. The vehicle positioning method in a weak GNSS environment according to claim 1, wherein two hidden layers of an LSTM network of the position prediction network are arranged, a network input layer has 7 neurons, a length of inputted time series data is 30, and an output layer comprises three neurons.

7. The vehicle positioning method in a weak GNSS environment according to claim 1, wherein two hidden layers of an LSTM network of the position correction network are arranged, and an output layer comprises three neurons.

8. A vehicle positioning system in a weak GNSS environment, comprising:
a data acquisition module configured to preprocess system operation data information of an autonomous vehicle in a normal driving state, wherein the system operation data information comprises latitude and longitude data acquired from a GNSS system and three-axis acceleration, three-axis angular velocity, and heading information acquired from an INS system;
a position prediction network module configured to train a position prediction network with the preprocessed three-axis acceleration, three-axis angular velocity, and heading information acquired from the INS system; and, by taking the three-axis acceleration, three-axis angular velocity, and heading information acquired from the INS system as inputs of the trained prediction network, output the supervision information of the prediction network composed of a difference value between a measured value of the GNSS system and a measured value of the INS system;
a position correction network module configured to train a position correction network according to the supervision information in the step S2 and the pre-processed three-axis acceleration, three-axis angular velocity, heading information, and supervision information of the position correction network acquired from the INS system; and similarly, by taking the three-axis acceleration, three-axis angular velocity, and heading information acquired from the INS system as inputs of the trained position correction network, output an error between the position predicted value and a measured value of the GNSS system, to correct a predicted value of the position prediction network; and
an output module configured to, in a weak GNSS environment or in case of GNSS interruption, by taking first-order differences of the three-axis acceleration, three-axis angular velocity, and heading information acquired from the INS system and posture information of the autonomous vehicle as inputs of the trained position prediction network and the position correction network, further correct the predicted value outputted by the position prediction network to obtain a final predicted value of position information of the autonomous vehicle.

9. A computer device, comprising a memory, a processor, and a computer program stored in the memory and executable on the processor, wherein the processor, when executing the computer program, implements the steps of the vehicle positioning method in a weak GNSS environment according to claim 1.

10. A computer-readable storage medium, storing a computer program, wherein when executed by a processor, the computer program implements the steps of the vehicle positioning method in a weak GNSS environment according to claim 1.
